(19) United States
(12) Patent Application Publication
(10) Pub. No.: US 2026/0039203 A1
(43) Pub. Date: Feb. 5, 2026

(54) Dual-Phase Constant On-Time Power Converter and Control Method

(71) Applicant: M3 Technology Inc., Taipei (TW)

(72) Inventors: Xiaoyu Xi, Dallas, TX (US); Bo Yang, Allen, TX (US); David Meng, Los Altos, CA (US)

(21) Appl. No.: 18/793,689

(22) Filed: Aug. 2, 2024

(51) Int. Cl. H02M 3/158; H02M 1/00

(52) U.S. Cl. CPC H02M 3/1586; H02M 1/0016

(57) ABSTRACT

An apparatus includes a first phase on-timer configured to produce a first reset signal for determining a turn-off time instant of a high-side switch of a first phase of a power converter, a feedback control circuit configured to produce a first set signal for determining a turn-on time instant of the high-side switch of the first phase of the power converter, a second phase on-timer configured to produce a second reset signal for determining a turn-off time instant of a high-side switch of a second phase of the power converter, and a delay generator configured to produce a delay signal for determining a phase shift between the first phase and the second phase of the power converter.

### TECHNICAL FIELD

The present invention relates to a dual-phase power converter, and, in particular embodiments, to a dual-phase constant on-time power converter.

### BACKGROUND

As technologies further advance, a variety of computing and mobile devices such as laptops, mobile phones, tablet PCs, digital cameras, MP3 players and/or the like, have become popular. With fast advance in communication, computing and mobile devices, more and more systems need low voltage and high current power supplies with fast transient response. At the same time, low quiescent current is also important for those systems as many of them are powered by batteries. Among various power supply control mechanisms, constant on-time control offers a rapid transient response and low quiescent current for switching mode power converters.

FIG. 1 illustrates a constant on-time power converter. The constant on-time power converter comprises a high-side switch Q1, a low-side switch Q2, an inductor L and an output capacitor C.

As shown in FIG. 1, switches Q1 and Q2 are connected in series between an input voltage bus VIN and ground. Switches Q1 and Q2 form a power stage 152. The inductor L is connected between a common node of Q1 and Q2, and the output terminal VOUT. The common node of Q1 and Q2 is denoted as SW. The output capacitor C is connected between VOUT and ground. A load is coupled between VOUT and ground.

The control circuit of the constant on-time power converter comprises a comparator 156, an on-time generator 154, a control logic block 150 and a voltage divider formed by a first resistor R1 and a second resistor R2 connected in series between VOUT and ground.

As shown in FIG. 1, the inverting input of the comparator 156 is employed to detect the output voltage VOUT through the voltage divider formed by resistors R1 and R2. The signal fed into the inverting input of the comparator 156 is denoted as a feedback signal FB. The non-inverting input of the comparator 156 is connected to a predetermined reference VREF. The output of the comparator 156 is fed into the on-time generator 154. The output signal of the comparator 156 is denoted as COMP (a comparison output signal).

The on-time generator 154 is able to determine the turn-on time instant of Q1 based on the COMP signal. In addition, the on-time generator 154 determines the on-time duration based on the desired output voltage and other circuit operating parameters. The on-time duration remains constant for a given set of conditions.

In operation, the comparator 156 compares the output voltage with the reference voltage VREF. When the output voltage drops below the reference voltage VREF, the comparator 156 generates a pulse, which triggers Q1 to turn on. A timer inside the on-time generator 154 is started simultaneously with the turn-on of Q1. The timer runs for a pre-set on-time duration. Once the timer reaches the end of the pre-set on-time duration, it configures Q1 to turn off. In other words, the output TON of the on-time generator 154 includes both the turn-on and turn-off time instants of Q1.

As shown in FIG. 1, the output of the on-time generator 154 is fed into the control logic block 150. The control logic block 150 is employed to generate a high-side gate drive signal HSON and a low-side gate drive signal LSON based upon TON generated by the on-time generator 154. Furthermore, the control logic block 150 adds a suitable delay between the high-side gate drive signal HSON and the low-side gate drive signal LSON. As shown in FIG. 1, the high-side gate drive signal HSON is applied to the gate of Q1. The low-side gate drive signal LSON is applied to the gate of Q2.

FIG. 1 further illustrates a timing diagram of various signals associated with constant on-time power converter. The timing diagram has seven rows. The first row represents the feedback signal FB and the predetermined reference VREF. The second row represents the output (COMP) of the comparator 156. The third row represents the voltage on the output TON of the on-time generator 154. The fourth row represents the high-side gate drive signal HSON. The fifth row represents the low-side gate drive signal LSON. The sixth row represents the voltage on the switching node SW. The seventh row represents the current flowing through the inductor L.

As shown in FIG. 1, at t1, the feedback signal FB drops below the predetermined reference VREF. The comparator 156 generates a pulse (COMP). In response to this pulse, TON changes from a logic low state to a logic high state. TON is fed into the control logic block 150 in which the logic high state of TON is converted into a gate drive signal to turn on Q1. Once Q1 is turned on, the voltage on the switching node SW is equal to VIN. From t1 to t2, Q1 remains on, and the current flowing through the inductor ramps up in a linear manner as shown in FIG. 1. At t2, the timer in the on-time generator 154 reaches the end of the pre-set on-time duration. TON changes from a logic high state to a logic low state. In response to this logic low state, Q1 is turned off and Q2 is turned on. Once Q2 is turned on, the voltage on the switching node SW is equal to the ground potential. From t2 to t3, Q2 remains on, and the current flowing through the inductor ramps down in a linear manner as shown in FIG. 1.

For some high current applications with a high load current (e.g., 20 A), multi-phase power converters have many advantageous features in comparison with single-phase converters. For example, multi-phase power converters have lower input/output current ripple, smaller output capacitance and inductance, and fast transient response. Furthermore, the structure of the multi-phase power converters helps spread thermal stress, thereby improving system thermal performance. In order to achieve the advantageous features described above, the gate drive control signals in a multi-phase converter should be phase-shifted evenly so that the load current can be evenly distributed in different phases of the multi-phase converter.

For some high current applications, it would be desirable to use a dual-phase power converter or a multi-phase power converter to share the power demanded by the load. Due to its variable frequency nature, conventional constant on-time control is not suitable for controlling multi-phase power converters unless complex circuits and/or control mechanisms, such as a phase-locked loop (PLL) for frequency synchronization, are used.

Furthermore, for a multi-phase constant on-time power converter, current sharing between different phases is an important feature. In particular, it is desirable to share the load current evenly between different phases to reduce thermal stress and improve reliability. It would be desirable to provide an apparatus and/or a method for enabling the multi-phase constant on-time power converter employing to provide fast transient response and good current sharing under a variety of operating conditions.

### SUMMARY

Technical advantages are generally achieved, by embodiments of this disclosure which describe a dual-phase constant on-time power converter.

In accordance with an embodiment, an apparatus comprises a first phase on-timer configured to produce a first reset signal for determining a turn-off time instant of a high-side switch of a first phase of a power converter, a feedback control circuit configured to produce a first set signal for determining a turn-on time instant of the high-side switch of the first phase of the power converter, a second phase on-timer configured to produce a second reset signal for determining a turn-off time instant of a high-side switch of a second phase of the power converter, and a delay generator configured to produce a delay signal for determining a phase shift between the first phase and the second phase of the power converter.

In accordance with another embodiment, a method comprises generating a first set signal for determining a turn-on time instant of a high-side switch of a first phase of a power converter, generating a delay signal for determining a phase shift between the first phase and a second phase of the power converter, based on the delay signal, generating a second set signal for determining a turn-on time instant of a high-side switch of the second phase of the power converter, generating, by a first phase on-timer, a first reset signal for determining a turn-off time instant of the high-side switch of the first phase of the power converter, and generating, by a second phase on-timer, a second reset signal for determining a turn-off time instant of the high-side switch of the second phase of the power converter.

In accordance with yet another embodiment, a dual-phase power converter comprises a first step-down converter comprising a first high-side switch, a first low-side switch, and a first inductor, wherein the first high-side switch and the first low-side switch are connected in series between an input voltage bus and ground, and the first inductor is connected between a common node of the first high-side switch and the first low-side switch, and an output terminal of the power converter, a second step-down converter comprising a second high-side switch, a second low-side switch, and a second inductor, wherein the second high-side switch and the second low-side switch are connected in series between the input voltage bus and ground, and the second inductor is connected between a common node of the second high-side switch and the second low-side switch, and the output terminal of the power converter, and a control apparatus comprising a first on-timer configured a first on-timer configured to produce a first reset signal for determining a turn-off time instant of the first high-side switch of the power converter, a feedback control circuit configured to produce a first set signal for determining a turn-on time instant of the first high-side switch of the power converter, a second on-timer configured to produce a second reset signal for determining a turn-off time instant of the second high-side switch of the power converter, and a delay generator configured to produce a delay signal for determining a phase shift between the first step-down converter and the second step-down converter.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a constant on-time power converter;

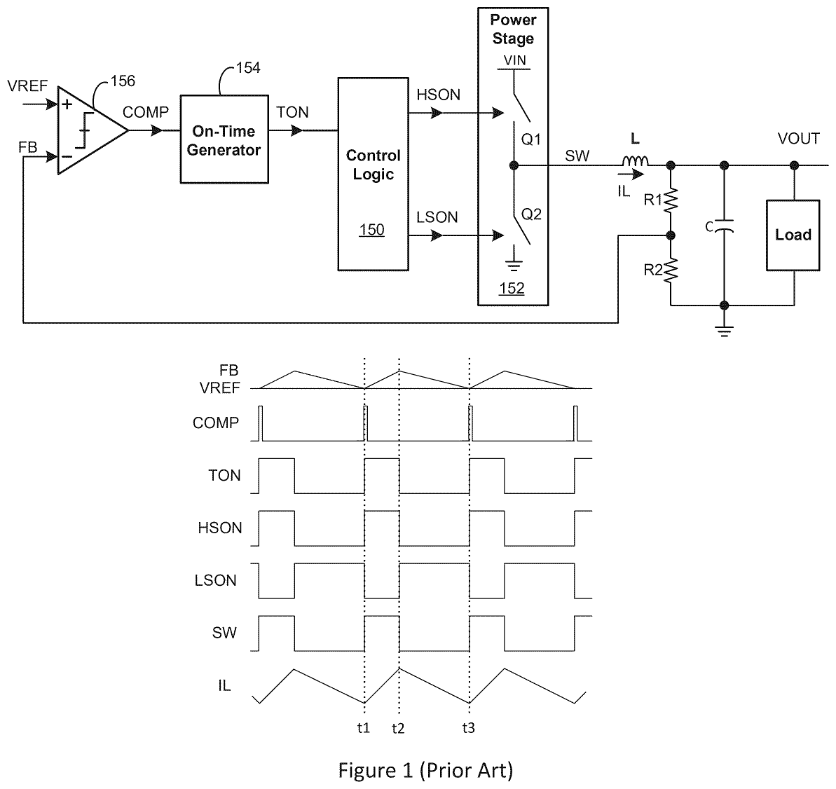

FIG. 2 illustrates a schematic diagram of a dual-phase constant on-time power converter in accordance with various embodiments of the present disclosure;

FIG. 3 illustrates a timing diagram of various signals associated with dual-phase constant on-time power converter shown in FIG. 2 in accordance with various embodiments of the present disclosure;

FIG. 4 illustrates a schematic diagram of the first on-time generator shown in FIG. 2 in accordance with various embodiments of the present disclosure;

FIG. 5 illustrates a schematic diagram of the second on-time generator shown in FIG. 2 in accordance with various embodiments of the present disclosure;

FIG. 6 illustrates a schematic diagram of the error current generator shown in FIG. 2 in accordance with various embodiments of the present disclosure;

FIG. 7 illustrates a schematic diagram of the delay generator shown in FIG. 2 in accordance with various embodiments of the present disclosure;

FIG. 8 illustrates a timing diagram of various signals associated with the delay generator shown in FIG. 7 in accordance with various embodiments of the present disclosure;

FIG. 9 illustrates a schematic diagram of another dual-phase constant on-time power converter in accordance with various embodiments of the present disclosure;

FIG. 10 illustrates a block diagram of a multi-phase constant on-time power converter in accordance with various embodiments of the present disclosure;

FIG. 11 a block diagram of the second phase of the multi-phase constant on-time power converter shown in FIG. 10 in accordance with various embodiments of the present disclosure; and

FIG. 12 illustrates a flow chart of a method for controlling the dual-phase constant on-time power converter shown in FIG. 2 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to preferred embodiments in a specific context, namely a dual-phase constant on-time power converter. The invention may also be applied, however, to a variety of power converters. Hereinafter, various embodiments will be explained in detail with reference to the accompanying drawings.

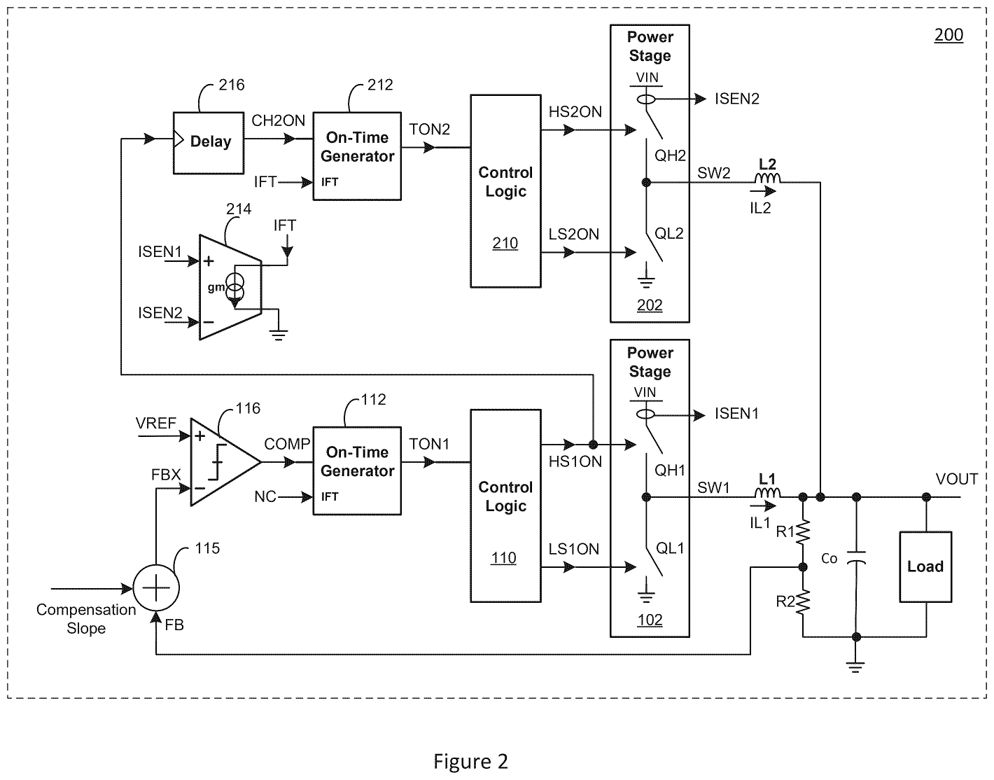

FIG. 2 illustrates a schematic diagram of a dual-phase constant on-time power converter in accordance with various embodiments of the present disclosure. The dual-phase constant on-time power converter 200 comprises a first buck converter and a second buck converter. The first buck converter is a first step-down converter. The second buck converter is a second step-down converter. These two buck converters are connected in parallel between an input VIN and an output VOUT.

As shown in FIG. 2, the first buck converter comprises a high-side switch QH1, a low-side switch QL1 and an inductor L1. Switches QH1 and QL1 are connected in series between VIN and ground. L1 is connected between a common node of QH1 and QL1, and VOUT. The common node of QH1 and QL1 is denoted as SW1. Throughout the description, the first buck converter may be alternatively referred to as a first phase of the dual-phase constant on-time power converter 200. The first phase functions as a master phase of the dual-phase constant on-time power converter 200. Throughout the description, the first phase may be alternatively referred to as a master phase of the dual-phase constant on-time power converter 200.

The second buck converter comprises switches a high-side switch QH2, a low-side switch QL2 and an inductor L2. Switches QH2 and QL2 are connected in series between VIN and ground. L2 is connected between a common node of QH2 and QL2, and VOUT. The common node of QH2 and QL2 is denoted as SW2. Throughout the description, the second buck converter may be alternatively referred to as a second phase of the dual-phase constant on-time power converter 200.

The second phase functions as a slave phase of the dual-phase constant on-time power converter 200. Throughout the description, the second phase may be alternatively referred to as a slave phase of the dual-phase constant on-time power converter 200.

As shown in FIG. 2, the output inductor L1 of the first step-down converter and the output inductor L2 of the second step-down converter are connected together and further connected to a load. An output capacitor Co and the load are connected in parallel between VOUT and ground.

The switches (e.g., QH1) shown in FIG. 2 may be implemented as n-type metal oxide semiconductor (NMOS) transistors. Alternatively, the switches may be implemented as other suitable controllable devices such as metal oxide semiconductor field effect transistor (MOSFET) devices, bipolar junction transistor (BJT) devices, super junction transistor (SJT) devices, insulated gate bipolar transistor (IGBT) devices, gallium nitride (GaN) based power devices, any combinations thereof and the like.

The control circuit of the dual-phase constant on-time power converter 200 comprises a comparator 116, a first on-time generator 112, a first control logic block 110, an error current generator 214, a delay generator 216, a second on-time generator 212 and a second control logic block 210.

As shown in FIG. 2, the inverting input of the comparator 116 is configured to receive a modified feedback signal FBX. As shown in FIG. 2, FBX is a sum of a feedback signal FB and a predetermined compensation slope. The feedback signal FB is tapped from a voltage divider formed by resistors R1 and R2. As such the feedback signal FB is proportional to the output voltage VOUT. The non-inverting input of the comparator 116 is connected to a predetermined reference VREF. The output of the comparator 116 is fed into the first on-time generator 112. The output signal of the comparator 116 is denoted as a COMP signal. Throughout the description, the COMP signal is alternatively referred to as a first set signal. The first set signal is employed to determine the turn-on time instant of QH1.

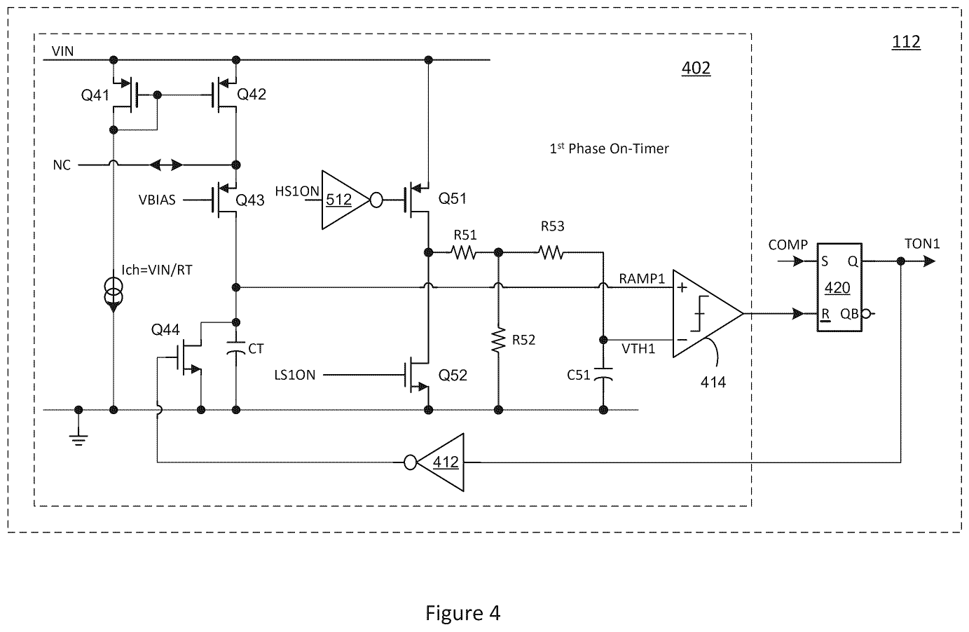

Based on the COMP signal generated by the comparator 116, the first on-time generator 112 is able to determine the turn-on time instant of QH1. In addition, the first on-time generator 112 is able to determine the on-time duration of QH1 based on the desired output voltage and other circuit parameters. The on-time duration remains constant for a given set of conditions. The detailed structure and operating principles of the first on-time generator 112 will be discussed below with respect to FIG. 4.

In operation, the comparator 116 compares the output voltage with the reference voltage VREF. When the output voltage drops below the reference voltage, the comparator 116 generates a pulse (COMP), which triggers QH1 to turn on. A timer inside the first on-time generator 112 is started simultaneously with the turn-on of QH1. The timer runs for the pre-set on-time duration. Once the timer reaches the end of the pre-set on-time duration, it configures QH1 to turn off.

Since the first on-time generator 112 is able to determine both the turn-on and turn-off time instants of QH1, the output TON1 of the first on-time generator 112 includes the gate drive signal of QH1. QH1 and HL1 are the high-side and low-side switches of the first phase. These two switches are turned on and off in a complementary manner. The gate drive signal of QL1 can be derived from the gate drive signal of QH1.

As shown in FIG. 2, the output of the first on-time generator 112 is fed into the first control logic block 110. The first control logic block 110 is employed to generate a high-side gate drive signal HS1ON and a low-side gate drive signal LS1ON based upon TON1 generated by the first on-time generator 110. Furthermore, the first control logic block 110 adds a suitable delay between the high-side gate drive signal HS1ON and the low-side gate drive signal LS1ON. As shown in FIG. 2, the high-side gate drive signal HS1ON is applied to the gate of QH1. The low-side gate drive signal LS1ON is applied to the gate of QL1.

The error current generator 214 is configured to receive a first current sense signal ISEN1, a second current sense signal ISEN2. As shown in FIG. 2, ISEN1 is sensed from the current flowing through QH1. ISEN1 is proportional to a current flowing through QH1. ISEN2 is sensed from the current flowing through QH2. ISEN2 is proportional to a current flowing through QH2.

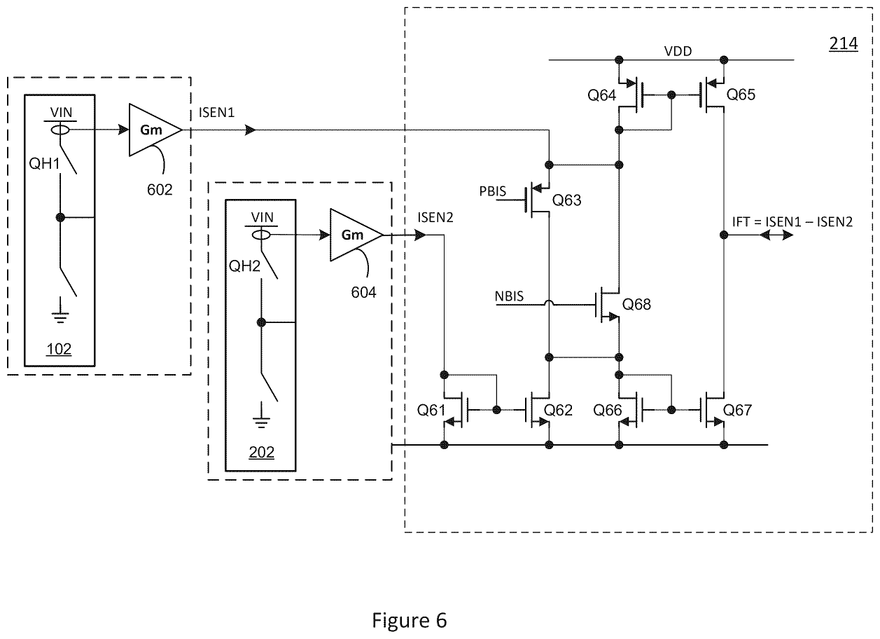

As shown in FIG. 2, ISEN1 is fed into a non-inverting input of the error current generator 214. ISEN2 is fed into an inverting input of the error current generator 214. Based on the received current sense signals ISEN1 and ISEN2, the error current generator 214 is configured to generate an error current IFT. IFT is a signal representative of the difference between ISEN1 and ISEN2. IFT is used to achieve current sharing between the master phase and the slave phase. The detailed structure and operating principles of the error current generator 214 will be discussed below with respect to FIG. 6.

The delay generator 216 is configured to receive the high-side gate drive signal HS1ON. In response to the leading edge of HS1ON, the delay generator 216 is able to generate a pulse CH2ON. Throughout the description, the pulse CH2ON is alternatively referred to as a delay signal.

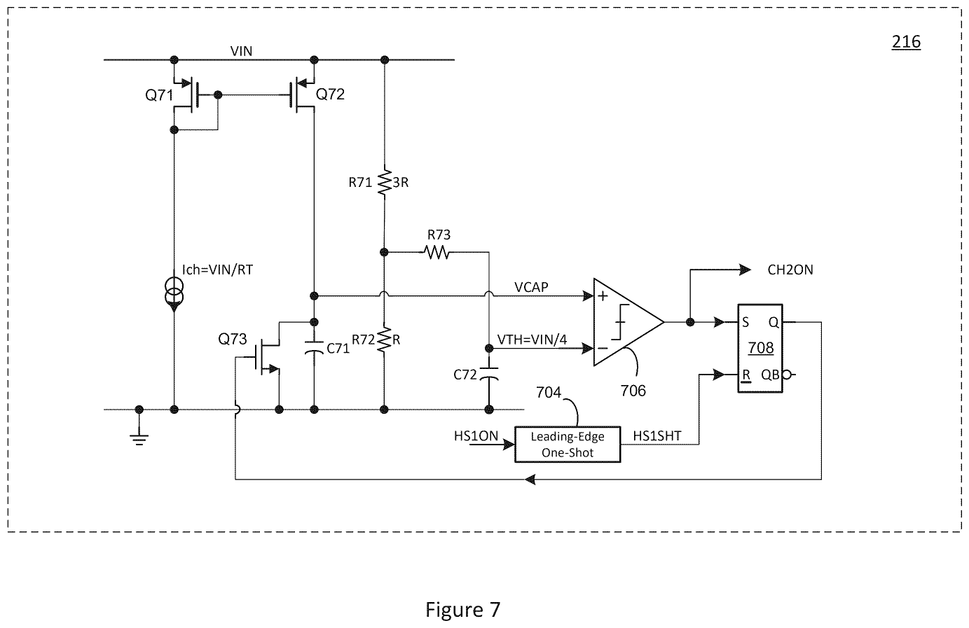

In some embodiments, the phase shift between the leading edge of CH2ON and the leading edge of HS1ON is equal to 180 degrees. In other words, the pulse CH2ON is shifted horizontally relative to the high-side gate drive signal HS1ON by 180 degrees. Since CH2ON is used to determine the turn-on time instant of QH2, the phase shift between leading edge of HS1ON and the leading edge of HS2ON is equal to 180 degrees. In other words, the master phase and the slave phase are configured to operate with a phase shift of 180 degrees. The detailed structure and operating principles of the delay generator 216 will be discussed below with respect to FIG. 7.

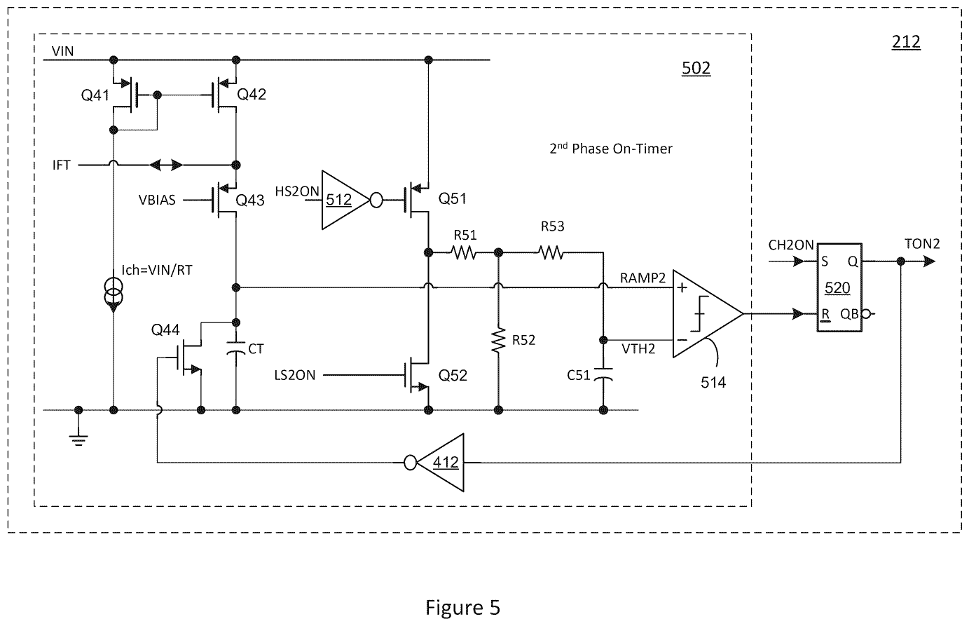

The second on-time generator 212 is configured to receive the pulse CH2ON and the error current IFT. Based on CH2ON and IFT, the second on-time generator 212 is able to determine the turn-on time instant of QH2. In addition, the second on-time generator 212 is able to determine the on-time duration of QH2 based on the desired output voltage and other circuit parameters. Furthermore, based on the error current IFT, the second on-time generator 212 is able to adjust the on-time of QH2 so as to achieve current sharing between the master phase and the slave phase. The detailed structure and operating principles of the second on-time generator 212 will be discussed below with respect to FIG. 5.

As shown in FIG. 2, the output of the second on-time generator 212 is fed into the second control logic block 210. The second control logic block 210 is employed to generate a high-side gate drive signal HS2ON and a low-side gate drive signal LS2ON based upon TON2 generated by the second on-time generator 210. Furthermore, the second control logic block 210 adds a suitable delay between the high-side gate drive signal HS2ON and the low-side gate drive signal LS2ON. As shown in FIG. 2, the high-side gate drive signal HS2ON is applied to the gate of QH2. The low-side gate drive signal LS2ON is applied to the gate of QL2.

In operation, the slave phase is shifted by 180 degrees from the master phase. This is accomplished by turning on the high-side switch of the slave phase after a delay of half a switching period following the activation of the high-side switch of the master phase. In operation, when HS1ON rises, a pulse CH2ON is generated after half a switching period to start the on-time generator of the slave phase. This half-period delay can be referenced from either the HS1ON rise edge or the TONI rise edge, as both are effectively the same in terms of phase shift. The switching period can be calculated with proper design parameters, achieving reasonable accuracy. Consequently, the 180-degree phase shift is also reasonably accurate. The slave phase always starts its switching cycle halfway through the switching period of the master phase, ensuring both phases run at exactly the same frequency and have identical switching periods.

One advantageous feature of the control circuit of the dual-phase constant on-time power converter 200 shown in FIG. 2 is that the control circuit provides a simple and reliable solution for controlling the dual-phase power converter. In particular, the system operation frequency is determined by the first on-time generator 112. The second on-time generator 212 is used to achieve current sharing between the master phase and the slave phase. Furthermore, the phase shift between the two phases is ensured with the proposed delay mechanism. The control circuit helps provide ultra-fast transient response and simple control circuitry.

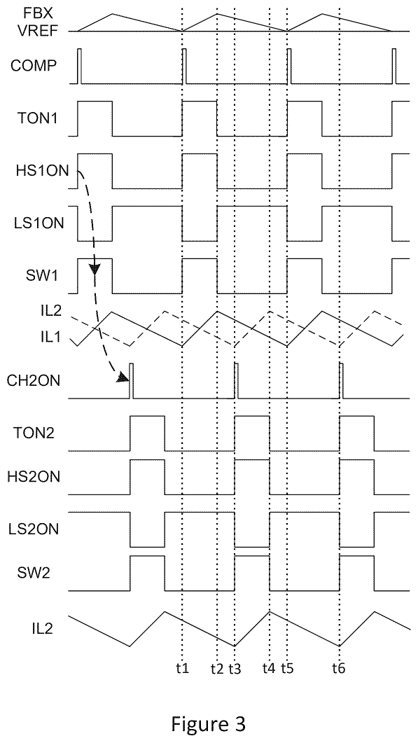

FIG. 3 illustrates a timing diagram of various signals associated with dual-phase constant on-time power converter shown in FIG. 2 in accordance with various embodiments of the present disclosure. The horizontal axis of FIG. 3 represents intervals of time. There are thirteen rows. The first row represents the feedback signal FBX and the predetermined reference VREF. The second row represents the output voltage COMP of the comparator 116. The third row represents the voltage on the output TON1 of the first on-time generator 112. The fourth row represents the high-side gate drive signal HS1ON. The fifth row represents the low-side gate drive signal LS1ON. The sixth row represents the voltage on the switching node SW1. The seventh row represents the current IL1 flowing through the inductor L1 and the current IL2 (dashed line) flowing through the inductor L2. The eighth row represents the pulse CH2ON generated by the delay generator 216. The ninth row represents the voltage on the output TON2 of the second on-time generator 212. The tenth row represents the high-side gate drive signal HS2ON. The eleventh row represents the low-side gate drive signal LS2ON. The twelfth row represents the voltage on the switching node SW2. The thirteenth row represents the current IL2 flowing through the inductor L2.

As shown in FIG. 3, at t1, once the feedback signal FBX drops below the predetermined reference VREF, the comparator 116 generates a pulse (COMP). In response to this pulse, TON1 changes from a logic low state to a logic high state. TONI is fed into the first control logic block 110. In response to the logic high state of TON1, the high-side gate drive signal HS1ON changes from a logic low state to a logic high state, thereby turning on QH1. Once QH1 is turned on, the voltage on the switching node SW1 is equal to VIN. From t1 to t2, QH1 remains on, and the current flowing through the inductor L1 ramps up in a linear manner as shown in FIG. 4.

At t2, the timer inside the first on-time generator 112 reaches the end of the pre-set on-time duration. TON1 changes from a logic high state to a logic low state. In response to this logic low state, the high-side gate drive signal HS1ON changes from a logic high state to a logic low state. The low-side gate drive signal LS1ON changes from a logic low state to a logic high state. Consequently, QH1 is turned off, and QL1 is turned on. Once QL1 is turned on, the voltage on the switching node SW1 is equal to the ground potential. From t2 to t5, QL1 remains on, and the current flowing through the inductor L1 ramps down in a linear manner as shown in FIG. 3.

After QH1 is turned on at t1, in response to the leading edge of HS1ON, the delay generator 216 is able to generate a pulse CH2ON (a delay signal). In some embodiments, the phase shift between the leading edge of CH2ON and the leading edge of HS1ON is equal to 180 degrees.

As shown in FIG. 3, the pulse CH2ON is generated at t3. In response to the logic high state of CH2ON, the high-side gate drive signal HS2ON changes from a logic low state to a logic high state, thereby turning on QH2. From t3 to t4, QH2 remains on, and the current flowing through the inductor L2 ramps up in a linear manner as shown in FIG. 4.

At t4, the timer inside the second on-time generator 212 reaches the end of the pre-set on-time duration. The high-side gate drive signal HS2ON changes from a logic high state to a logic low state. The low-side gate drive signal LS2ON changes from a logic low state to a logic high state. Consequently, QH2 is turned off and QL2 is turned on. From t4 to t6, QL2 remains on, and the current flowing through the inductor L2 ramps down in a linear manner as shown in FIG. 3.

As shown in FIG. 3, the first phase and the second phase are configured to operate with a phase shift of 180 degrees. The 180-degree phase shift interleaving offers significant advantages. For example, when these two phases are interleaved with a 180-degree phase shift, the ripple currents from each phase partially cancel each other out. This leads to a significant reduction in the overall output voltage ripple. Furthermore, due to the reduced ripple, smaller output capacitors and inductors can be used, which can save space and cost.

FIG. 4 illustrates a schematic diagram of the first on-time generator shown in FIG. 2 in accordance with various embodiments of the present disclosure. The first on-time generator 112 comprises a first phase on-timer 402 and a first latch 420. The first phase on-timer 402 comprises a first ramp generator configured to generate a first ramp signal RAMP1, a first threshold generator configured to generate a first voltage threshold VTH1 and a first comparator 414 configured to compare the first ramp signal RAMP1 with the first voltage threshold VTH1.

As shown in FIG. 4, the first ramp generator comprises a ramp generation current mirror comprising a first ramp transistor Q41 and a second ramp transistor Q42, a ramp generation current source Ich, a third ramp transistor Q43, a ramp capacitor CT, a fourth ramp transistor Q44 and a ramp inverter 412.

As shown in FIG. 4, a gate of the first ramp transistor Q41 is connected to a gate of the second ramp transistor Q42. The ramp generation current source Ich is connected in series with the first ramp transistor Q41 between an input voltage bus VIN and ground. A common node of the ramp generation current source Ich and the first ramp transistor Q41 is connected to the gate of the first ramp transistor Q41. The second ramp transistor Q42, the third ramp transistor Q43 and the ramp capacitor CT are connected in series between the input voltage bus VIN and ground. The first ramp signal is generated at a common node of the third ramp transistor Q43 and the ramp capacitor CT. The fourth ramp transistor Q44 is connected in parallel with the ramp capacitor CT. A gate of the fourth ramp transistor Q44 is configured to receive the first on-time signal TON1 through the ramp inverter 412. The gate of the third ramp transistor Q43 is connected to a predetermined bias voltage VBIAS.

In operation, the ramp generation current source Ich provides a current proportional to the input voltage VIN. In some embodiments, Ich is equal to VIN divided by RT. The resistance value of RT is a predetermined. Through the ramp generation current mirror, the current generated by Ich is mirrored to charge the ramp capacitor CT. In operation, once the high-side switch QH1 is turned on, the fourth ramp transistor Q44 is turned off, and the ramp capacitor CT is charged to generate the first ramp signal RAMP1.

As shown in FIG. 4, the first threshold generator comprises a first threshold generation transistor Q51, a second threshold generation transistor Q52, a first threshold generation resistor R51, a second threshold generation resistor R52, a third threshold generation resistor R53, a threshold generation capacitor C51 and a threshold generation inverter 512.

As shown in FIG. 4, the first threshold generation transistor Q51 and the second threshold generation transistor Q52 are connected in series between the input voltage bus VIN and ground. A gate of the first threshold generation transistor Q51 is configured to receive the first high-side gate drive signal HS1ON through the threshold generation inverter 512. A gate of the second threshold generation transistor Q52 is configured to receive the first low-side gate drive signal LS2ON.

The first threshold generation resistor R51 and the second threshold generation resistor R52 are connected in series between a common node of the first threshold generation transistor Q51 and the second threshold generation transistor Q52, and ground. In some embodiments, a resistance value of the first threshold generation resistor R51 is equal to a resistance value of the second threshold generation resistor R52.

The third threshold generation resistor R53 and the threshold generation capacitor C51 are connected in series between a common node of the first threshold generation resistor R51 and the second threshold generation resistor R52, and ground. The first voltage threshold VTH1 is generated at a common node of the third threshold generation resistor R53 and the threshold generation capacitor C51.

The first comparator 414 is configured to receive the first ramp signal RAMPI and the first voltage threshold VTH1. As shown in FIG. 4, an inverting input of the first comparator 414 is configured to receive the first voltage threshold VTH1. A non-inverting input of the first comparator 414 is configured to receive the first ramp signal RAMP1. Based on the received signals, the first comparator 414 is configured to generate a first reset signal fed into the reset input of the first latch 420. In operation, the first reset signal is generated once the first ramp signal RAMP1 reaches the first voltage threshold VTH1. The set input of the first latch 420 is configured to receive the COMP signal. An output of the first latch 420 is configured to generate the first on-time signal TON1. The leading edge of the COMP signal determines the turn-on time instant of QH1 (the rising edge of TON1). The first reset signal generated by the first comparator 414 determines the turn-off time instant of QH1 (the falling edge of TON1).

The system operation frequency of the dual-phase constant on-time power converter 200 is determined by the first on-time generator 112 shown in FIG. 4. In operation, Q51 and Q52 mimic the operation of QH1 and QL1. R53 and C51 function as a low-pass filter. As a result, the average voltage on the common node Q51 and Q52 is equal to the duty cycle (D) times the input voltage VIN. The resistance value of R51 is equal to the resistance value of R52. R51 and R52 form a voltage divider to scale down the average voltage by 2. The first voltage threshold VTH1 can be expressed by the following equation:

$$V TH 1 = \frac{VIN}{2} \times D \qquad ( 1 )$$

The peak value of the first ramp signal RAMPI is equal to the first voltage threshold VTH1. During the on-time of QH1, the charge current can charge the voltage across CT up to a level equal to VTH1. This can be expressed by the following equation:

$$CT \times V TH 1 = Ich \times TON 1 \qquad ( 2 )$$

Ich is equal to VIN divided by RT. Substitute Equation (1) into Equation (2), the following relationship can be obtained:

$$C T \times \frac{VIN}{2} \times D = \frac{VIN}{R T} \times TON 1 \qquad ( 3 )$$

TON1 is equal to the duty cycle (D) times the switching period (T_{SW}). Equation (3) can be simplified as:

$$\frac{C T}{2} = \frac{1}{R T} \times Tsw \qquad ( 4 )$$

Based on Equation (4), the switching frequency F_{SW} can be expressed by the following equation:

$$Fsw = \frac{2}{R T \times C T} \qquad ( 5 )$$

Equation (5) indicates the switching frequency F_{SW} is determined by the values of RT and CT. Depending on different applications and design needs, the switching frequency F_{SW} can be adjusted through adjusting the value of RT and/or the value of CT.

FIG. 5 illustrates a schematic diagram of the second on-time generator shown in FIG. 2 in accordance with various embodiments of the present disclosure. The second on-time generator 212 comprises a second phase on-timer 502 and a second latch 520. The second phase on-timer 502 comprises a second ramp generator configured to generate a second ramp signal RAMP2, a second threshold generator configured to generate a second voltage threshold VTH2 and a second comparator 514 configured to compare the second ramp signal RAMP2 with the second voltage threshold VTH2 to generate a second reset signal fed into the reset input of the second latch 520. In operation, the second reset signal is generated once the second ramp signal RAMP2 reaches the second voltage threshold VTH2. The set input of the second latch 520 is configured to receive the delay signal CH2ON generated by the delay generator 216.

The second ramp generator 212 is similar to the first ramp generator 112 except that an error current IFT is injected into the second ramp generator 212 to adjust current balancing between the first phase and the second phase of the dual-phase constant on-time power converter 200. In particular, the error current IFT is proportional to the difference between ISEN1 and ISEN2. The error current IFT is injected into the second on-time generator 212 to adjust the on-time, thereby minimizing the difference between ISEN1 and ISEN2. The generation of the error current IFT will be described below with respect to FIG. 6.

In operation, the slave phase operates at the same frequency as the master phase, but calculates its own on-time in the same manner as the master phase. Consequently, the salve phase runs with a fixed duty cycle very close to that of the master phase. In an ideal dual-phase constant on-time power converter, both phases should operate at exactly the same duty cycle to meet the input and output requirements. However, with the control scheme in the present disclosure, each phase has its own on-time, with the frequency determined by the master phase through the feedback loop (the feedback loop modulates the off-time of the master phase to regulate the output). Therefore, each phase has its own duty cycle, which might differ slightly due to the mismatch between the on-time of the master phase and the on-time of the slave phase. However, the combined or average duty cycle of both phases should precisely meet the input and output requirements. For example, if the output voltage is equal to 50% of the input voltage, ideally, both phases should run at a 50% duty cycle. If there is a mismatch and the slave phase runs at a fixed duty cycle of 48%, the master phase will adjust its duty cycle to 52%, ensuring that the combined average duty cycle of the two phases meets the 50% requirement.

FIG. 6 illustrates a schematic diagram of the error current generator shown in FIG. 2 in accordance with various embodiments of the present disclosure. The error current generator 214 comprises a first error current detection current mirror comprising a first error current detection transistor Q61 and a second error current detection transistor Q62, a third error current detection transistor Q63, a second error current detection current mirror comprising a fourth error current detection transistor Q64 and a fifth error current detection transistor Q65, a third error current detection current mirror comprising a sixth error current detection transistor Q66 and a seventh error current detection transistor Q67, and an eighth error current detection transistor Q68.

As shown in FIG. 6, a drain of the first error current detection transistor Q61 is configured to receive a second current sense signal ISEN2 proportional to a current flowing through the high-side switch QH2 of the second phase of the power converter. The second current sense signal ISEN2 is generated by a transconductance amplifier 604. The current sense signal obtained from QH2 is a voltage signal. The transconductance amplifier 604 outputs a current signal proportional to the voltage signal fed into its input. A source of the first error current detection transistor Q61 is connected to ground. A gate of the first error current detection transistor Q61 is connected to a gate of the second error current detection transistor Q62 and the drain of the first error current detection transistor Q61.

The source of the third error current detection transistor Q63 is configured to receive a first current sense signal ISEN1 proportional to a current flowing through the high-side switch QH1 of the first phase of the power converter. The first current sense signal ISEN1 is generated by a transconductance amplifier 602. The current sense signal obtained from QH1 is a voltage signal. The transconductance amplifier 602 outputs a current signal proportional to the voltage signal fed into its input.

One skilled in the art will recognize that the current sense circuits illustrated in FIG. 6 is simply one embodiment and that other configurations for sensing the current flowing through a power converter can be employed. For example, ISEN1 may be sensed from the current flowing through the low-side switch QL1 of the first phase of the power converter. ISEN2 may be sensed from the current flowing through the low-side switch QL2 of the second phase of the power converter.

As shown in FIG. 6, the third error current detection transistor Q63 and the second error current detection transistor Q62 are connected in series. A gate of the third error current detection transistor Q63 is connected to a first predetermined bias voltage PBIS.

The eighth error current detection transistor Q68 is coupled between the second error current detection current mirror and the third error current detection current mirror. As shown in FIG. 6, the fourth error current detection transistor Q64, the eighth error current detection transistor Q68 and the sixth error current detection transistor Q66 are connected in series between a bias voltage bus VDD and ground. A gate of the eighth error current detection transistor Q68 is connected to a second predetermined bias voltage NBIS.

As shown in FIG. 6, a common node of the fourth error current detection transistor Q64 and the eighth error current detection transistor Q68 is connected to the source of the third error current detection transistor Q63. A common node of the eighth error current detection transistor Q68 and the sixth error current detection transistor Q66 is connected to a common node of the third error current detection transistor Q63 and the second error current detection transistor Q62.

The fifth error current detection transistor Q65 and the seventh error current detection transistor Q67 are connected in series between the bias voltage bus VDD and ground. The error current IFT is generated at a common node of the fifth error current detection transistor Q65 and the seventh error current detection transistor Q67.

In operation, through the first error current detection current mirror and the second error current detection current mirror, ISEN2 is mirrored into the output terminal of the error current generator 214. Likewise, through the third error current detection current mirror, ISEN1 is mirrored into the output terminal of the error current generator 214. As shown in FIG. 6, the error current IFT is equal to the difference between ISEN1 and ISEN2.

Referring back to FIG. 5, the error current IFT is injected into the on-time generator of the slave phase to adjust its on-time, thereby minimizing the difference between ISEN1 and ISEN2. The higher the transconductance gain (e.g., the gain of the transconductance amplifier 602 and/or the gain of the transconductance amplifier 604), the smaller the difference between ISEN1 and ISEN2, resulting in better current balance between the master phase and the slave phase.

It should be noted that the on-time of the master phase determines the switching frequency of the dual-phase constant on-time power converter 200, so the current balancing circuit (e.g., the error current generator) does not adjust the on-time of the master phase.

FIG. 7 illustrates a schematic diagram of the delay generator shown in FIG. 2 in accordance with various embodiments of the present disclosure. The delay generator 216 comprises a delay generation current mirror comprising a first delay generation transistor Q71 and a second delay generation transistor Q72, a delay generation current source Ich, a first delay generation capacitor C71, a third delay generation transistor Q73, a first delay generation resistor R71, a second delay generation resistor R72, a third delay generation resistor R73, a second delay generation capacitor C72, a delay generation comparator 706, a leading-edge one-shot circuit 704 and a delay generation latch 708.

As shown in FIG. 7, the delay generation current source Ich is connected in series with the first delay generation transistor Q71 between an input voltage bus VIN and ground. A common node of the delay generation current source Ich and the first delay generation transistor Q71 is connected to the gate of the first delay generation transistor Q71.

The second delay generation transistor Q72 and the first delay generation capacitor C71 are connected in series between the input voltage bus VIN and ground. The third delay generation transistor Q73 is connected in parallel with the first delay generation capacitor C71.

In operation, the delay generation current source Ich provides a current proportional to the input voltage VIN. In some embodiments, Ich is equal to VIN divided by RT. The resistance value of RT is a predetermined. Through the delay generation current mirror comprising a first delay generation transistor Q71 and a second delay generation transistor Q72, the current is mirrored to charge the first delay generation capacitor C71. Once the high-side switch QH1 is turned on, the delay generation latch 708 is configured to generate a logic low signal at the output Q. This logic low signal turns off the third delay generation transistor Q73. The first delay generation capacitor C71 is charged to generate a ramp signal (VCAP).

The first delay generation resistor R71 and the second delay generation resistor R72 are connected in series between the input voltage bus VIN and ground. In some embodiments, a ratio of a resistance value of the first delay generation resistor R71 to a resistance value of the second delay generation resistor R72 is equal to 3:1.

The third delay generation resistor R73 and the second delay generation capacitor C72 are connected in series between a common node of the first delay generation resistor R71 and the second delay generation resistor R72, and ground.

The delay generation comparator 706 has a non-inverting input connected to a common node of the second delay generation transistor Q72 and the first delay generation capacitor C71, an inverting input connected to a common node of the third delay generation resistor R73 and the second delay generation capacitor C72, and an output configured to generate the delay signal CH2ON.

The leading-edge one-shot circuit 704 is configured to receive a gate drive signal HS1ON of the high-side switch QH1 of the first phase of the power converter, and generate a pulse signal HS1SHT in response to a leading edge of the gate drive signal HS1ON of the high-side switch of the first phase of the power converter. The delay generation latch 708 has a set input configured to receive the delay signal CH2ON, a reset input configured to receive the pulse signal HS1SHT, and an output connected to a gate of the third delay generation transistor Q73.

In operation, once the ramp signal (VCAP) reaches the voltage threshold VTH, the delay generation comparator 706 generates a pulse CH2ON. The pulse CH2ON is alternatively referred to as the delay signal. The pulse CH2ON is fed into the delay generation latch 708. In response to the pulse, the delay generation latch 708 generates a logic high signal at the output Q. This logic high signal turns on the third delay generation transistor Q73, thereby resetting the first delay generation capacitor C71. By resetting the first delay generation capacitor C71, the output of the comparator 706 is driven to logic low.

In operation, R71 and R72 form a volage divider. The average voltage on the common node R71 and R72 is equal to the input voltage VIN divided by 4 (VIN/4). R73 and C72 function as a low-pass filter. As such, the threshold voltage on the common node R71 and R72 is equal to VIN/4.

The current for charging the first delay generation capacitor C71 is the same as that shown in FIG. 4. The threshold voltage is equal to one fourth of VIN. Therefore, the delay generation comparator 706 is triggered at one half of the switching period counting from the leading edge of the high-side gate drive signal HS1ON. In other words, the delay generator 216 generates the delay signal CH2ON after a 180-degree phase shift counting from the leading edge of the high-side gate drive signal HS1ON.

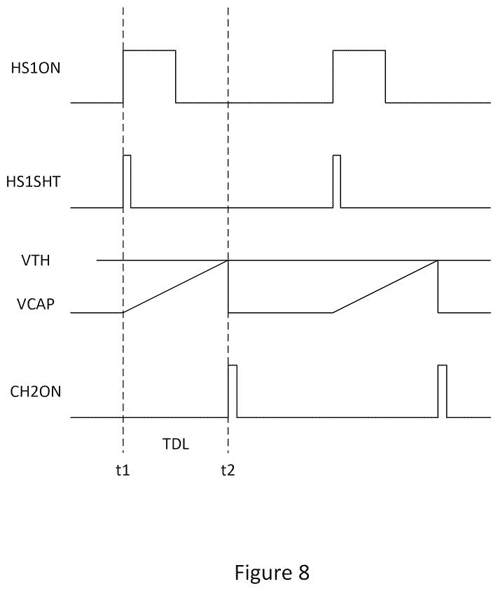

FIG. 8 illustrates a timing diagram of various signals associated with the delay generator shown in FIG. 7 in accordance with various embodiments of the present disclosure. The horizontal axis of FIG. 8 represents intervals of time. There are four rows. The first row

represents the high-side gate drive signal HS1ON. The second row represents the pulse signal HS1SHT. The third row represents the threshold voltage VTH and the voltage VCAP across the first delay generation capacitor C71. The fourth row represents the delay signal CH2ON generated by the delay generation comparator 706.

As shown in FIG. 8, at t1, the high-side gate drive signal HS1ON changes from a logic low state to a logic high state. Referring back to FIG. 7, in response to the leading edge of the high-side gate drive signal HS1ON, the leading-edge one-shot circuit 704 is configured to generate a pulse signal HS1SHT. At t1, the pulse signal HS1SHT is fed into the reset input of the delay generation latch 708. In response to the pulse signal HS1SHT fed into the reset input, the delay generation latch 708 is configured to generate a logic low signal at the output Q. This logic low signal turns off the third delay generation transistor Q73. Since Q73 is turned off, the charge current is able to charge the first delay generation capacitor C71. At t1, the first delay generation capacitor C71 is charged to generate a ramp signal (VCAP). As shown in FIG. 8, from t1 to t2, the voltage VCAP across the first delay generation capacitor C71 increases in a linear manner.

At t2, the voltage VCAP exceeds the threshold voltage VTH. Referring back to FIG. 7, once the voltage VCAP exceeds the voltage threshold VTH, the delay generation comparator 706 generates the pulse CH2ON.

The time duration TDL between t1 and t2 is the delay or phase shift between the leading edge of HS1ON (the high-side gate drive signal of the first phase) and the leading edge of HS2ON (the high-side gate drive signal of the second phase). In some embodiments, the phase shift between the first phase and the second phase is equal to 180 degrees.

Referring back to FIG. 7, the peak value of the voltage VCAP is equal to the threshold voltage VTH. During the time duration TDL, the charge current can charge the voltage across C71 up to a level equal to VTH. This can be expressed by the following equation:

$$CT \times V TH = Ich \times TDL \qquad ( 6 )$$

Ich is equal to VIN divided by RT. VTH is equal to VIN divided by 4. Equation (6) can be expressed by the following equation:

$$C T \times \frac{VIN}{4} = \frac{VIN}{R T} \times TDL \qquad ( 7 )$$

Based on Equation (7), the delay TDL can be expressed by the following equation:

$$TDL = \frac{R T \times C T}{4} \qquad ( 8 )$$

Referring back to Equation (4), the delay TDL is equal to one half of the switching period (T_{SW}). In other words, the phase shift between the leading edge of HS1ON and the leading edge of HS2ON is equal to 180 degrees (one half of T_{SW}).

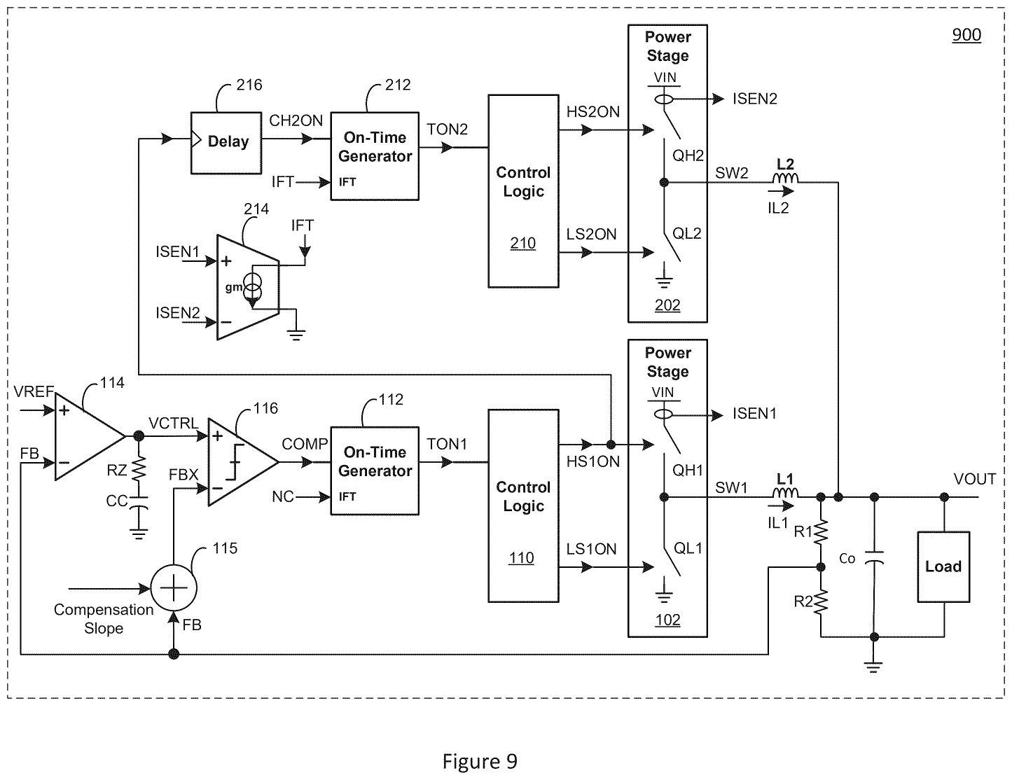

FIG. 9 illustrates a schematic diagram of another dual-phase constant on-time power converter in accordance with various embodiments of the present disclosure. The dual-phase constant on-time power converter 900 shown in FIG. 9 is similar to the dual-phase constant on-time power converter 200 shown in FIG. 2 except that an error amplifier 114 is employed to further improve the performance of the feedback loop. As shown in FIG. 9, a non-inverting input of the error amplifier 114 is configured to receive a predetermined reference VREF. An inverting input of the error amplifier 114 is configured to receive the feedback signal FB. The output of the error amplifier 114 is a control signal VCTRL fed into the non-inverting input of the comparator 116. A compensation network is connected between the output of the error amplifier 114 and ground. The compensation network comprises a compensation resistor RZ and a compensation capacitor CC. The compensation resistor RZ and the compensation capacitor CC are connected in series. The compensation resistor RZ and the compensation capacitor CC from a zero at (1/(RZ×CC)). This zero provided by the compensation network helps to stabilize the control loop and provide sufficient phase margin, thereby improving the transient response performance of the dual-phase constant on-time power converter 900.

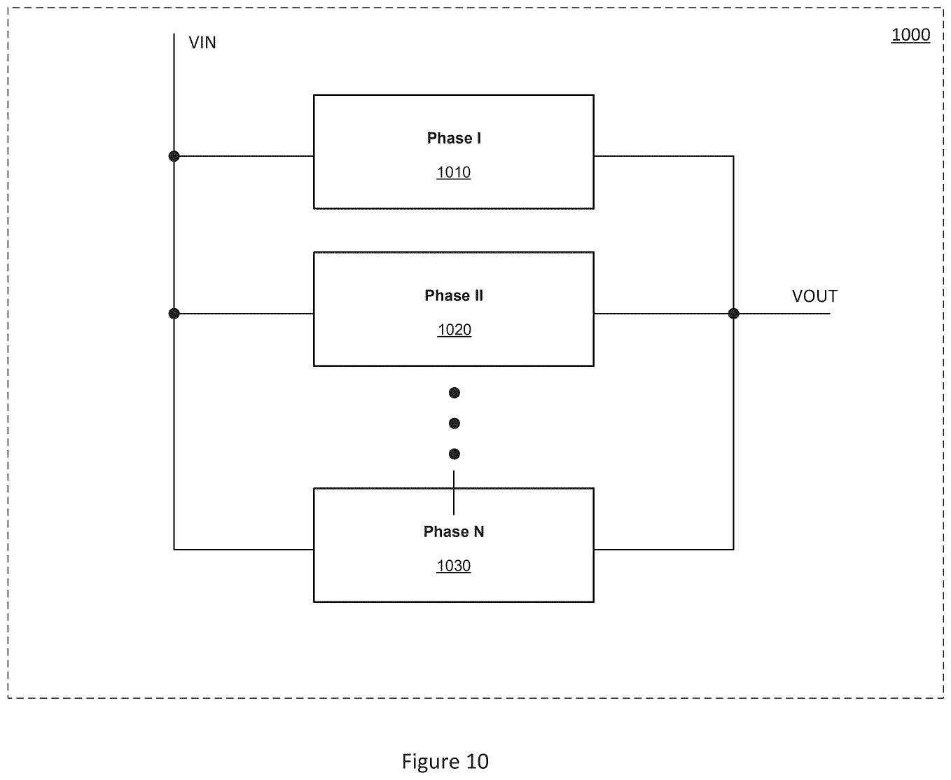

FIG. 10 illustrates a block diagram of a multi-phase constant on-time power converter in accordance with various embodiments of the present disclosure. The multi-phase constant on-time power converter 1000 comprises a plurality of phases. Each phase is formed by a buck converter. As shown in FIG. 10, a first phase 1010 is formed by a first step-down converter. A second phase 1020 is formed by a second step-down converter. An Nth phase 1030 is formed by a Nth step-down converter. These step-down converters are connected in parallel between an input VIN and an output VOUT.

In some embodiments, the first phase 1010 is the master phase of the multi-phase constant on-time power converter 1000. The rest phases are slave phases. In operation, the system operation frequency of the multi-phase constant on-time power converter 1000 is determined by the on-time generator of the master phase. The structure and operating principle of the on-time generator of the master phase have been described above with respect to FIG. 4, and hence are not discussed again to avoid repetition.

The phase shift between the two adjacent phases is equal to 360 degrees divided by N. For example, the multi-phase constant on-time power converter 900 comprises four phases. N is equal to 4. The phase shift between the two adjacent phases is equal to 90 degrees. The phase shift between two adjacent phases can be ensured with the proposed delay mechanism described above with respect to FIGS. 7-8.

In operation, each phase is configured to detect the current flowing through its high-side switch or low-side switch. To achieve balance among the plurality of phases, the sensed current signals (ISEN1, ISEN2, . . . , ISEN) can be averaged to create a reference current signal, ISEN_AVG. The current sense signal of each phase (e.g., ISEN2) is then compared to the reference current signal ISEN_AVG to produce an error current, which is used to fine-tune the on-time of the corresponding phase. The error current can be produced by the error current generator described above with respect to FIG. 6.

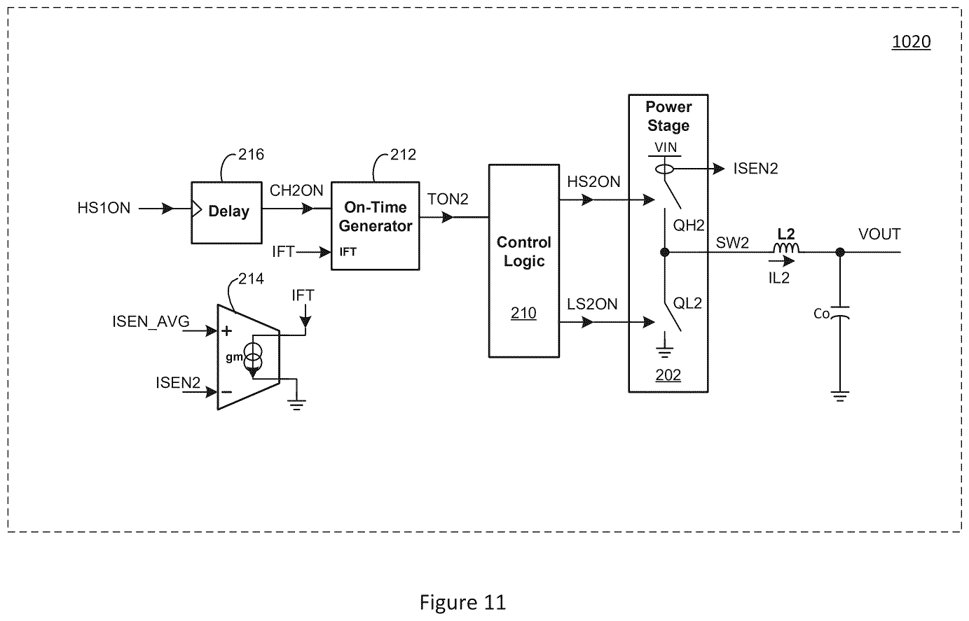

FIG. 11 illustrates a block diagram of the second phase of the multi-phase constant on-time power converter shown in FIG. 10 in accordance with various embodiments of the present disclosure. The second phase 1020 of the multi-phase constant on-time power converter 1000 is a slave phase. The structure of the second phase 1020 is similar to that of the second phase of the dual-phase constant on-time power converter shown in FIG. 2 except that the non-inverting input of the error current generator 214 is configured to receive the reference current signal ISEN_AVG. The error current IFT shown in FIG. 11 is equal to the difference between ISEN_AVG and ISEN2.

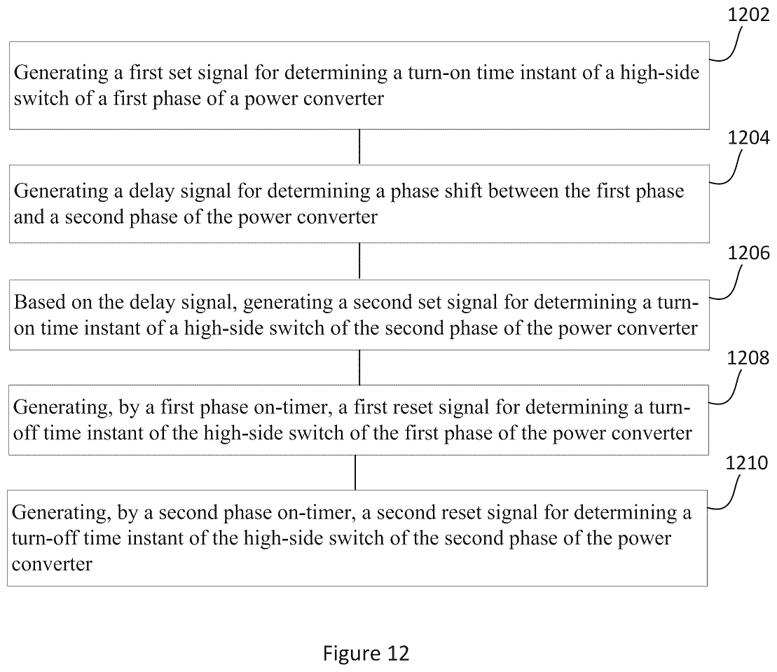

FIG. 12 illustrates a flow chart of a method for controlling the dual-phase constant on-time power converter shown in FIG. 2 in accordance with various embodiments of the present disclosure. This flowchart shown in FIG. 12 is merely an example, which should not unduly limit the scope of the claims. One of ordinary skill in the art would recognize many variations, alternatives, and modifications. For example, various steps illustrated in FIG. 12 may be added, removed, replaced, rearranged and repeated.

Referring back to FIG. 2, a power converter (e.g., the dual-phase constant on-time power converter 200) comprises a first buck converter and a second buck converter connected in parallel between an input power source and a load. The first buck converter is a first phase of the power converter. The second buck converter is a second phase of the power converter. The control circuit of the power converter comprises a comparator, a first on-time generator, a first control logic block, an error current generator, a delay generator, a second on-time generator and a second control logic block.

At step 1202, a first set signal is generated for determining a turn-on time instant of a high-side switch of a first phase of a power converter.

At step 1204, a delay signal is generated for determining a phase shift between the first phase and a second phase of the power converter.

At step 1206, based on the delay signal, a second set signal is generated for determining a turn-on time instant of a high-side switch of the second phase of the power converter.

At step 1208, a first reset signal is generated by a first phase on-timer for determining a turn-off time instant of the high-side switch of the first phase of the power converter.

At step 1210, a second reset signal is generated by a second phase on-timer for determining a turn-off time instant of the high-side switch of the second phase of the power converter.

The method further comprises generating the first set signal using a comparator having an inverting input configured to receive a feedback signal, and a non-inverting input configured to receive a predetermined reference.

The method further comprises generating the delay signal using a delay generator comprising a delay generation current mirror comprising a first delay generation transistor and a second delay generation transistor, and wherein a gate of the first delay generation transistor is connected to a gate of the second delay generation transistor, a delay generation current source connected in series with the first delay generation transistor between an input voltage bus of the power converter and ground, and wherein a common node of the delay generation current source and the first delay generation transistor is connected to the gate of the first delay generation transistor, a first delay generation capacitor, and wherein the second delay generation transistor and the first delay generation capacitor are connected in series between the input voltage bus of the power converter and ground, a third delay generation transistor connected in parallel with the first delay generation capacitor, a first delay generation resistor and a second delay generation resistor connected in series between the input voltage bus of the power converter and ground, wherein a ratio of a resistance value of the first delay generation resistor to a resistance value of the second delay generation resistor is equal to 3:1, a third delay generation resistor and a second delay generation capacitor connected in series between a common node of the first delay generation resistor and the second delay generation resistor, and ground, a delay generation comparator having a non-inverting input connected to a common node of the second delay generation transistor and the first delay generation capacitor, an inverting input connected to a common node of the third delay generation resistor and the second delay generation capacitor, and an output configured to generate the delay signal, a leading-edge one-shot circuit configured to receive a gate drive signal of the high-side switch of the first phase of the power converter, and generate a pulse signal in response to a leading edge of the gate drive signal of the high-side switch of the first phase of the power converter, and a delay generation latch having a set input configured to receive the delay signal, a reset input configured to receive the pulse signal, and an output connected to a gate of the third delay generation transistor.

The method further comprises injecting an error current into the second phase on-timer to adjust current balancing between the first phase and the second phase of the power converter, wherein the error current is generated by an error current generator.

The error current generator comprises a first error current detection current mirror

comprising a first error current detection transistor and a second error current detection transistor, and wherein a drain of the first error current detection transistor is configured to receive a second current sense signal proportional to a current flowing through the high-side switch of the second phase of the power converter, and a source of the first error current detection transistor is connected to ground, a third error current detection transistor having a source configured to receive a first current sense signal proportional to a current flowing through the high-side switch of the first phase of the power converter, and wherein the third error current detection transistor and the second error current detection transistor are connected in series, and a gate of the third error current detection transistor is connected to a first predetermined bias voltage, a second error current detection current mirror comprising a fourth error current detection transistor and a fifth error current detection transistor, a third error current detection current mirror comprising a sixth error current detection transistor and a seventh error current detection transistor, and an eighth error current detection transistor coupled between the second error current detection current mirror and the third error current detection current mirror, and wherein the fourth error current detection transistor, the eighth error current detection transistor and the sixth error current detection transistor are connected in series between a bias voltage bus and ground, a gate of the eighth error current detection transistor is connected to a second predetermined bias voltage, a common node of the fourth error current detection transistor and the eighth error current detection transistor is connected to the source of the third error current detection transistor, a common node of the eighth error current detection transistor and the sixth error current detection transistor is connected to a common node of the third error current detection transistor and the second error current detection transistor, and the fifth error current detection transistor and the seventh error current detection transistor are connected in series between the bias voltage bus and ground, and wherein the error current is generated at a common node of the fifth error current detection transistor and the seventh error current detection transistor.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
a first phase on-timer configured to produce a first reset signal for determining a turn-off time instant of a high-side switch of a first phase of a power converter;
a feedback control circuit configured to produce a first set signal for determining a turn-on time instant of the high-side switch of the first phase of the power converter;
a second phase on-timer configured to produce a second reset signal for determining a turn-off time instant of a high-side switch of a second phase of the power converter; and
a delay generator configured to produce a delay signal for determining a phase shift between the first phase and the second phase of the power converter.

2. The apparatus of claim 1, wherein the power converter is a dual-phase constant on-time power converter comprising:
the first phase comprising a first step-down converter; and
the second phase comprising a second step-down converter, and wherein an output inductor of the first step-down converter and an output inductor of the second step-down converter are connected together and further connected to a load.

3. The apparatus of claim 1, wherein:
the feedback control circuit comprises a comparator having an inverting input configured to receive a feedback signal, and a non-inverting input configured to receive a predetermined reference.

4. The apparatus of claim 1, wherein the first phase on-timer and a first latch form a first on-time generator configured to generate a first on-time signal fed into a first control logic block, and wherein:
based on the first on-time signal, the first control logic block is configured to generate a first high-side gate drive signal and a first low-side gate drive signal for driving the high-side switch and a low-side switch of the first phase of the power converter, respectively; and
the first phase on-timer comprises a first ramp generator configured to generate a first ramp signal, and a first threshold generator configured to generate a first voltage threshold, and wherein the first reset signal is generated once the first ramp signal exceeds the first voltage threshold.

5. The apparatus of claim 4, wherein the first ramp generator comprises:
a ramp generation current mirror comprising a first ramp transistor and a second ramp transistor, and wherein a gate of the first ramp transistor is connected to a gate of the second ramp transistor;
a ramp generation current source connected in series with the first ramp transistor between an input voltage bus of the power converter and ground, and wherein a common node of the ramp generation current source and the first ramp transistor is connected to the gate of the first ramp transistor;
a third ramp transistor and a ramp capacitor, and wherein the second ramp transistor, the third ramp transistor and the ramp capacitor are connected in series between the input voltage bus of the power converter and ground, and wherein the first ramp signal is generated at a common node of the third ramp transistor and the ramp capacitor; and
a fourth ramp transistor connected in parallel with the ramp capacitor, and wherein a gate of the fourth ramp transistor is configured to receive the first on-time signal through a ramp inverter.

6. The apparatus of claim 4, wherein the first threshold generator comprises:
a first threshold generation transistor and a second threshold generation transistor connected in series between an input voltage bus of the power converter and ground, and wherein a gate of the first threshold generation transistor is configured to receive the first high-side gate drive signal through a threshold generation inverter, and a gate of the second threshold generation transistor is configured to receive the first low-side gate drive signal;
a first threshold generation resistor and a second threshold generation resistor connected in series between a common node of the first threshold generation transistor and the second threshold generation transistor, and ground; and
a third threshold generation resistor and a threshold generation capacitor connected in series between a common node of the first threshold generation resistor and the second threshold generation resistor, and ground, and wherein the first voltage threshold is generated at a common node of the third threshold generation resistor and the threshold generation capacitor.

7. The apparatus of claim 4, further comprising a first comparator, wherein:
an inverting input of the first comparator is configured to receive the first voltage threshold;
a non-inverting input of the first comparator is configured to receive the first ramp signal; and
an output of the first comparator is configured to generate the first reset signal.

8. The apparatus of claim 4, wherein:
a set input of the first latch is configured to receive the first set signal generated by the feedback control circuit;
a reset input of the first latch is configured to receive the first reset signal generated by the first phase on-timer; and
an output of the first latch is configured to generate the first on-time signal.

9. The apparatus of claim 4, wherein the second phase on-timer and a second latch form a second on-time generator configured to generate a second on-time signal fed into a second control logic block, and wherein:
based on the second on-time signal, the second control logic block is configured to generate a second high-side gate drive signal and a second low-side gate drive signal for driving the high-side switch and a low-side switch of the second phase of the power converter, respectively; and
the second phase on-timer comprises a second ramp generator configured to generate a second ramp signal, and a second threshold generator configured to generate a second voltage threshold, and wherein the second reset signal is generated once the second ramp signal exceeds the second voltage threshold.

10. The apparatus of claim 9, wherein:
the second ramp generator is similar to the first ramp generator except that an error current is injected into the second ramp generator to adjust current balancing between the first phase and the second phase of the power converter; and
a configuration of the second latch is similar to a configuration of the first latch except that a set input of the second latch is configured to receive the delay signal generated by the delay generator.

11. The apparatus of claim 10, wherein the error current is generated by an error current generator comprising:
a first error current detection current mirror comprising a first error current detection transistor and a second error current detection transistor, and wherein:
a drain of the first error current detection transistor is configured to receive a second current sense signal proportional to a current flowing through the high-side switch of the second phase of the power converter;
a gate of the first error current detection transistor is connected to a gate of the second error current detection transistor and a drain of the first error current detection transistor; and
a source of the first error current detection transistor is connected to ground;
a third error current detection transistor having a source configured to receive a first current sense signal proportional to a current flowing through the high-side switch of the first phase of the power converter, and wherein the third error current detection transistor and the second error current detection transistor are connected in series, and a gate of the third error current detection transistor is connected to a first predetermined bias voltage;
a second error current detection current mirror comprising a fourth error current detection transistor and a fifth error current detection transistor;
a third error current detection current mirror comprising a sixth error current detection transistor and a seventh error current detection transistor; and
an eighth error current detection transistor coupled between the second error current detection current mirror and the third error current detection current mirror, and wherein:
the fourth error current detection transistor, the eighth error current detection transistor and the sixth error current detection transistor are connected in series between a bias voltage bus and ground;
a gate of the eighth error current detection transistor is connected to a second predetermined bias voltage;
a common node of the fourth error current detection transistor and the eighth error current detection transistor is connected to the source of the third error current detection transistor;
a common node of the eighth error current detection transistor and the sixth error current detection transistor is connected to a common node of the third error current detection transistor and the second error current detection transistor; and
the fifth error current detection transistor and the seventh error current detection transistor are connected in series between the bias voltage bus and ground, and wherein the error current is generated at a common node of the fifth error current detection transistor and the seventh error current detection transistor.

12. The apparatus of claim 1, wherein the delay generator comprises:
a delay generation current mirror comprising a first delay generation transistor and a second delay generation transistor, and wherein a gate of the first delay generation transistor is connected to a gate of the second delay generation transistor;
a delay generation current source connected in series with the first delay generation transistor between an input voltage bus of the power converter and ground, and wherein a common node of the delay generation current source and the first delay generation transistor is connected to the gate of the first delay generation transistor;
a first delay generation capacitor, and wherein the second delay generation transistor and the first delay generation capacitor are connected in series between the input voltage bus of the power converter and ground;
a third delay generation transistor connected in parallel with the first delay generation capacitor;
a first delay generation resistor and a second delay generation resistor connected in series between the input voltage bus of the power converter and ground;
a third delay generation resistor and a second delay generation capacitor connected in series between a common node of the first delay generation resistor and the second delay generation resistor, and ground;
a delay generation comparator having a non-inverting input connected to a common node of the second delay generation transistor and the first delay generation capacitor, an inverting input connected to a common node of the third delay generation resistor and the second delay generation capacitor, and an output configured to generate the delay signal;
a leading-edge one-shot circuit configured to receive a gate drive signal of the high-side switch of the first phase of the power converter, and generate a pulse signal in response to a leading edge of the gate drive signal of the high-side switch of the first phase of the power converter; and
a delay generation latch having a set input configured to receive the delay signal, a reset input configured to receive the pulse signal, and an output connected to a gate of the third delay generation transistor.

13. The apparatus of claim 12, wherein:
a current flowing through the delay generation current source is proportional to an input voltage of the power converter; and
the phase shift determined by the delay signal is equal to 180 degrees.

14. The apparatus of claim 1, wherein:
the first phase is a master phase of the power converter; and
the second phase is a slave phase of the power converter.

15. A method comprising:
generating a first set signal for determining a turn-on time instant of a high-side switch of a first phase of a power converter;
generating a delay signal for determining a phase shift between the first phase and a second phase of the power converter;
based on the delay signal, generating a second set signal for determining a turn-on time instant of a high-side switch of the second phase of the power converter;
generating, by a first phase on-timer, a first reset signal for determining a turn-off time instant of the high-side switch of the first phase of the power converter; and
generating, by a second phase on-timer, a second reset signal for determining a turn-off time instant of the high-side switch of the second phase of the power converter.

16. The method of claim 15, further comprising:
generating the first set signal using a comparator having an inverting input configured to receive a feedback signal, and a non-inverting input configured to receive a predetermined reference.

17. The method of claim 15, further comprising:
generating the delay signal using a delay generator comprising:
a delay generation current mirror comprising a first delay generation transistor and a second delay generation transistor, and wherein a gate of the first delay generation transistor is connected to a gate of the second delay generation transistor;
a delay generation current source connected in series with the first delay generation transistor between an input voltage bus of the power converter and ground, and wherein a common node of the delay generation current source and the first delay generation transistor is connected to the gate of the first delay generation transistor;
a first delay generation capacitor, and wherein the second delay generation transistor and the first delay generation capacitor are connected in series between the input voltage bus of the power converter and ground;
a third delay generation transistor connected in parallel with the first delay generation capacitor;
a first delay generation resistor and a second delay generation resistor connected in series between the input voltage bus of the power converter and ground;
a third delay generation resistor and a second delay generation capacitor connected in series between a common node of the first delay generation resistor and the second delay generation resistor, and ground;
a delay generation comparator having a non-inverting input connected to a common node of the second delay generation transistor and the first delay generation capacitor, an inverting input connected to a common node of the third delay generation resistor and the second delay generation capacitor, and an output configured to generate the delay signal;
a leading-edge one-shot circuit configured to receive a gate drive signal of the high-side switch of the first phase of the power converter, and generate a pulse signal in response to a leading edge of the gate drive signal of the high-side switch of the first phase of the power converter; and
a delay generation latch having a set input configured to receive the delay signal, a reset input configured to receive the pulse signal, and an output connected to a gate of the third delay generation transistor.

18. The method of claim 15, further comprising:
injecting an error current into the second phase on-timer to adjust current balancing between the first phase and the second phase of the power converter, wherein the error current is generated by an error current generator.

19. The method of claim 18, wherein the error current generator comprises:
a first error current detection current mirror comprising a first error current detection transistor and a second error current detection transistor, and wherein:
a drain of the first error current detection transistor is configured to receive a second current sense signal proportional to a current flowing through the high-side switch of the second phase of the power converter; and
a source of the first error current detection transistor is connected to ground;
a third error current detection transistor having a source configured to receive a first current sense signal proportional to a current flowing through the high-side switch of the first phase of the power converter, and wherein the third error current detection transistor and the second error current detection transistor are connected in series, and a gate of the third error current detection transistor is connected to a first predetermined bias voltage;
a second error current detection current mirror comprising a fourth error current detection transistor and a fifth error current detection transistor;
a third error current detection current mirror comprising a sixth error current detection transistor and a seventh error current detection transistor; and
an eighth error current detection transistor coupled between the second error current detection current mirror and the third error current detection current mirror, and wherein:
the fourth error current detection transistor, the eighth error current detection transistor and the sixth error current detection transistor are connected in series between a bias voltage bus and ground;
a gate of the eighth error current detection transistor is connected to a second predetermined bias voltage;
a common node of the fourth error current detection transistor and the eighth error current detection transistor is connected to the source of the third error current detection transistor;
a common node of the eighth error current detection transistor and the sixth error current detection transistor is connected to a common node of the third error current detection transistor and the second error current detection transistor; and
the fifth error current detection transistor and the seventh error current detection transistor are connected in series between the bias voltage bus and ground, and wherein the error current is generated at a common node of the fifth error current detection transistor and the seventh error current detection transistor.

20. A dual-phase power converter comprising:
a first step-down converter comprising a first high-side switch, a first low-side switch, and a first inductor, wherein:
the first high-side switch and the first low-side switch are connected in series between an input voltage bus and ground; and
the first inductor is connected between a common node of the first high-side switch and the first low-side switch, and an output terminal of the power converter;
a second step-down converter comprising a second high-side switch, a second low-side switch, and a second inductor, wherein:
the second high-side switch and the second low-side switch are connected in series between the input voltage bus and ground; and
the second inductor is connected between a common node of the second high-side switch and the second low-side switch, and the output terminal of the power converter; and
a control apparatus comprising:
a first on-timer configured to produce a first reset signal for determining a turn-off time instant of the first high-side switch of the power converter;
a feedback control circuit configured to produce a first set signal for determining a turn-on time instant of the first high-side switch of the power converter;
a second on-timer configured to produce a second reset signal for determining a turn-off time instant of the second high-side switch of the power converter; and
a delay generator configured to produce a delay signal for determining a phase shift between the first step-down converter and the second step-down converter.
